(19) United States
(12) Patent Application Publication
(10) Pub. No.: US 2001/0036620 A1
(43) Pub. Date: Nov. 1, 2001

(54) On-line Notation system

(75) Inventors: Scott C. Peer, Gulph Mills, PA (US); John S. Alexander, Voorhees, NJ (US); Gerald A. Beirne, Berwyn, PA (US); Kevin E. Corcoran, Media, PA (US); Sue A. Groveman, St. David's, PA (US); Daniel M. Kessler, Aliso Viejo, CA (US); John H. Lewis, Glassboro, NJ (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Lyrrus Inc. d/b/a GVOX, Philadelphia, PA (US)

(21) Appl. No.: 09/801,359

(22) Filed: Mar. 7, 2001

Related U.S. Application Data
(60) Provisional application No. 60/187,634, filed on Mar. 8, 2000.
(60) Provisional application No. 60/223,889, filed on Aug. 9, 2000.

(51) Int. Cl. G09B 5/00

(52) U.S. Cl. 434/307 R

(57) ABSTRACT

A system for making a lesson authored by a teacher accessible to a class of one or more students and for making homework authored by a student belonging to the class accessible to the teacher. The system includes a first client, a second client, and a server computer, all of which are connected to a computer network. The server computer maintains a database including information about the teacher, the student, the class and the lesson. The server computer provides a script to the first client computer and to the second client computer for executing a notation computer program. The notation computer program is utilized to author the lesson or the homework. The lesson or the homework is transferred from the first or the second client computer to the server computer for making the lesson or the homework accessible to the students of the class or the teacher.

### CROSS REFERENCE TO RELATED APPLICATIONS

This application claims the benefit of U.S. Provisional Application No. 60/187,634, filed Mar. 8, 2000, entitled “G-Vox Online Notation Service”; and U.S. Provisional Application No. 60/223,889, filed Aug. 9, 2000, entitled “Online Notation Service”.

### BACKGROUND OF THE INVENTION

The present invention relates to providing musical material to persons connected to a computer network, and more particularly, the present invention relates to a system for use by an author to generate a notational representation of the musical material on a first computer attached to a computer network, and making the notational representation of the musical material accessible to a class of persons each of which has a second computer connected to the computer network, whereupon each member of the class may interact with the notational representation of the musical material to provide comments and/or revisions of the notational representation of the musical material which are made accessible to the author.

The world wide web (WWW), a subnet of the Internet, is a suitable medium for distributing instructional material to persons having computer access to the Internet. There are also a variety of services which utilize the WWW to provide instructional material to persons having computer access to the WWW. The material may be offered without a fee or, it may be necessary to subscribe to the service to receive the material. Generally however, the material is not customized to a particular user or even to a small class of users, but rather, is designed for general consumption. Further, there is not a means for directly interacting with the material to provide an on-line revision of the material or a response back to the author of the material.

It is well known to distribute music over telecommunications channels by means of data streams encoded to conform to the Musical Instrument Digital Interface (MIDI). This method is employed by OnlineConservatory.com to exchange music on-line between a teacher and a student. However, this technique does not provide for distributing the music notation of a musical score to the student, which music notation must be provided by other means.

There are apparatus/computer programs that provide for entering musical information for creating a music notation of the music from a computer keyboard, mouse or a MIDI enabled musical instrument. For example, U.S. Pat. No. 4,366,741 discloses an electronic piano having a keyboard and a microprocessor for controlling a cathode ray tube device to provide a video note display on a staff. Similarly, U.S. Pat. No. 4,954,804 discloses a method and apparatus for entering rhythmic and melodic information from a MIDI enabled device into a computer for transcribing the information into music notation. However, neither of the aforementioned patents discloses or suggests distributing the resulting music notation to other persons over a telecommunications channel.

Similarly, Allegro® and Print Music® are commercially available computer programs distributed by Coda Music Technology, Inc., which execute in a personal computer to create the music notation of a musical composition from either a keyboard, a mouse or a MIDI enabled musical instrument. However, neither Allegro® nor Print Music®) includes the capability to provide instructional material to a student in the form of a music notation over a telecommunications channel, such that a student may interact with the music notation according to the teacher's instructions and provide a revision of the music notation back to the teacher for the teacher's evaluation.

The graphics capabilities of the WWW allow for the music notation of a musical score to be scanned or otherwise entered into a computer. Further, the Internet also provides a convenient means for distributing the music notation to persons having access to the Internet. Accordingly, there is a need for a system by which a musical composition in the form of a music notation can be distributed to students over a computer network. Further, there is a need for an apparatus by which a teacher can define one or more classes of students having similar educational needs and develop a suite of music lessons which are customized for each class. Further, there is a need for an apparatus by which a musical transcript in the form of music notation can be incorporated into each lesson. Also, there is a need for an apparatus which provides access to the lessons by students designated as being members of the class where the students may be co-located or may be remote from the teacher. Also, there is a need for an apparatus which allows each student to revise the musical transcript and to submit the revised transcript to the teacher for evaluation. Additionally, there is a need for an apparatus that executes the transcript so that the student may listen to the transcript as it plays and provides the correct fingering of the musical transcript as the transcript executes in the apparatus. Further, there is a need to allow the student to interact with the transcript and for the apparatus to provide on-line feedback to the student about the correctness of the student's performance while the student is performing.

### BRIEF SUMMARY OF THE INVENTION

Briefly stated, the present invention comprises a system for making a lesson authored by a teacher accessible to a class of one or more students, and for making homework authored by a student belonging to the class accessible to the teacher, the system comprising: a first client computer connected to a computer network, the first client computer being under the control of the student; a second client computer connected to the computer network, the second client computer being under the control of the teacher; and a server computer connected to the computer network. The server computer maintains a database including information about the teacher, the student, the class and the lesson, wherein the server computer provides a script to the first client computer and to the second client computer for executing a notation computer program in the first and in the second client computers. The notation computer program is utilized to author at least one of the lesson and the homework. The at least one of the lesson and the homework is transferred from the respective first and the second client computer to the server computer for making the at least one of the lesson and the homework accessible to one of the students of the class and the teacher.

The present invention further comprises a method for making a lesson authored by a teacher accessible to a class of one or more students and for making homework authored by one of the students belonging to the class accessible to the teacher, the method comprising the steps of: connecting a first client computer to a computer network, the first client computer being under the control of the student; connecting a second client computer to the computer network, the second client computer being under the control of the teacher; and connecting a server computer to the computer network. The server computer maintains a database including information about the teacher, the student, the class and the lesson. The server computer provides a script to the first client computer and to the second client computer for enabling the execution of a notation computer program in the first and the second client computers. The notation computer program is utilized to author at least one of the lesson and the homework wherein the at least one of the lesson and the homework is transferred from the respective first and the second client computer to the server computer for making the at least one of the lesson and the homework accessible to at least one of the class of the students and the teacher.

The present invention also comprises a method for a teacher to author a lesson which is accessible to a class of one or more of students, the method comprising the steps of: connecting a client computer under the control of the teacher to a server computer; entering a class code associated with a class into the client computer and transferring the class code to the server computer, transferring a script from the server computer to the client computer in response to a request from the client computer wherein the script causes a music notation computer program to execute in the client computer; entering musical information into the client computer to form the lesson, the lesson comprising at least one of a musical transcript and text formed by utilizing the music notation computer program; and transferring the lesson from the client computer to the server computer wherein the lesson is accessible to the class of students.

The present invention additionally provides a method for a student to gain access to a lesson prepared by a teacher and for the student to submit homework to the teacher, the method comprising the steps of: connecting a first client computer under the control of the student to a server computer; entering a class code associated with a class of one or more of the students into the first client computer and transferring the class code to the server computer; receiving from the server computer, a list of lessons which are stored on the server computer and which are available to the students belonging to the class; requesting access to one of the lessons stored in the server computer, the requested lesson having been previously transferred to the server computer from a second client computer, the second client computer being under the control of the teacher; transferring the requested lesson from the server computer to the first client computer in response to the request from the first client computer, whereupon a script within the requested lesson causes a music notation computer program to execute in the first client computer, thereby making the requested lesson accessible to the student; entering the homework into the first client computer, the homework comprising at least one of a musical transcript and text formed by the music notation program; and transferring the homework from the first client computer to the server computer wherein the homework is accessible to the teacher.

The present invention also includes an apparatus for displaying a virtual representation of a person playing a musical instrument, said apparatus comprising: a storage device for storing the virtual representation of said person playing the instrument; a computer connected to the storage device for receiving a command specifying a note to be played and for selecting the virtual representation stored in the storage device to correspond with the playing of the specified note; and a video display connected to the computer for receiving and displaying the virtual representation of the person playing the specified note on the musical instrument.

The present invention also includes a method for displaying a virtual representation of a musical instrument being played by a person, the method comprising the steps of: storing the virtual representation of the person playing the instrument; receiving a command specifying a note to be played; selecting the virtual representation to correspond with the specified note; and displaying the virtual representation of the person playing the specified note.

The present invention also includes a method for providing information to a performer about a musical performance of a musical composition, the method comprising the steps of: displaying a musical transcript of the composition; highlighting a first note of the composition as registered on the transcript; comparing a first note of the performance with the first note of the composition; highlighting a second note of the composition if the first note of the performance matches the first note of the composition; and continuing to highlight the first note of the composition until the first note of the performance matches the first note of the composition.

### BRIEF DESCRIPTION OF THE SEVERAL VIEWS OF THE DRAWINGS

The foregoing summary as well as the following detailed description of the preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic block diagram of the preferred embodiment of the present invention including an on-line notation service (ONS) server and a plurality of ONS clients;

FIG. 2 is a schematic block diagram of the ONS server shown in FIG. 1;

FIG. 3 is a schematic block diagram of the software architecture of the ONS server shown in FIG. 1;

FIG. 4 is a schematic block diagram of the software architecture of one of the ONS clients shown in FIG. 1;

FIG. 5 is a flow diagram of the steps for creating a lesson on one of the ONS clients and transferring the lesson to the ONS server;

FIG. 6 is a pictorial representation of the ONS client notation screen;

FIG. 7 is a pictorial representation of a virtual instrument displayed on the notation screen of FIG. 6; and

FIG. 8 is a flowchart of the steps for preparing homework on one of the ONS clients and transferring the homework to the ONS server.

### DETAILED DESCRIPTION OF THE INVENTION

A portion of the disclosure of this patent document contains material which is subject to copyright protection. The copyright owner has no objection to the facsimile reproduction by anyone of the patent disclosure, as it appears in the U.S. Patent and Trademark Office files or records, but otherwise, reserves all copyright rights whatsoever.

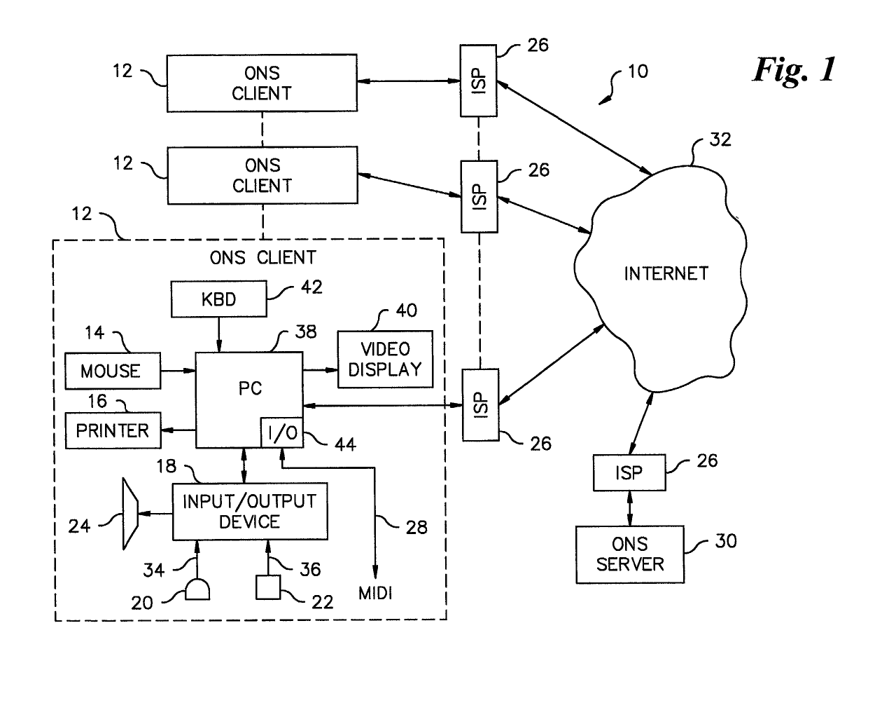

Referring to the drawings, wherein like numerals are used to indicate like elements throughout the several figures and the use of the indefinite article “a” may indicate a quantity of one, or more than one, of an element, there is shown in FIG. 1 a block diagram of the preferred embodiment of an on-line notation service (ONS) system 10 for making one or more lessons authored by a teacher accessible to a class of one or more students and for making homework authored by a student belonging to the class accessible to the teacher. The system 10 supports a plurality of students and a plurality of teachers. Each teacher may create a plurality of classes to which one or more students may be a member. Each teacher may also create one or more lessons which may be shared with other teachers and may be allocated to one or more classes. Normally, the homework prepared by a student is made accessible only to the teacher to which the student submits the homework, however, with the students permission, the homework may be shared with other teachers and students. As would be appreciated by those skilled in the art, the ONS system 10 is not limited to providing access to teachers for providing lessons and reviewing homework and to students for reviewing lessons and submitting homework. For instance, the ONS system 10 could be used to distribute published music or music created by users of the ONS to both subscribers and to non-subscribers of the ONS. In the former case, for instance, a sheet music company could convert existing sheet music content into the ONS file format and store the music in the ONS system 10 for purchase. A purchaser, could select music from a listing of available music stored in the ONS system 10, view the musical score, play the music back, change the key signature, purchase the music and print the musical score.

Preferably, the ONS system 10 includes at least one ONS server 30 and a plurality of ONS clients 12, each of which clients 12 being under the control of either a student or a teacher and all of which clients 12 and the server 30 being connected to a computer network 32. Preferably, each ONS client 12 includes a computer 38 under the control of a student or a teacher. Each ONS client 12 may be located, for instance, in a home, school a library or any public place. The ONS clients 12 and the ONS server 30 may be remote from each other such that connectivity between them is accomplished by a wide area network. Alternatively, the ONS clients 12 and the ONS server 30 may be co-located in the same classroom or the same building and connected together by a local area network.

In the preferred embodiment, the computer network 32 is the “Internet” and the server 30 and each client 12 are connected to the Internet via an Internet service provider 26. Preferably, the ONS system 10 is a member of the world wide web and utilizes the hypertext transfer protocol (HTTP) for the interchange of data between each client 12 and the server 30. However, it would be clear to those skilled in the art that the present invention is not limited to operating with the Internet. Other computer networks employing other protocols, such as a 10Base-T local area network or a wireless network conforming to IEEE 802.11b could be used, within the spirit and scope of the invention.

Preferably, each ONS client 12 comprises a computer 38 of a type having an open architecture called a personal computer (PC). The computer 38 comprises a storage device (not shown) having a portion for storing a computer executable program code (computer program). Desirably, the storage device includes a random access memory (RAM), a read only memory (ROM), and a hard disk memory connected within the computer 38 in an architecture well known to those skilled in the art. In addition to storing the computer program, the storage device stores the information representing the notes in the musical signal. Preferably, the computer 38 also includes a floppy disk drive and/or a CD-ROM drive for the purpose of entering computer programs and other information into the computer 38. The preferred embodiment of the computer 38 also includes a processor (not shown) for executing the computer program stored in the storage device and a communications interface (not shown) such as a modem, for connecting the computer 38 to the Internet 32 or to another computer network. The connection of the modem to the Internet 32 may be via a point-to-point telephone line, a local area network etc. In the preferred embodiment, the computer 12 operates under the Windows® operating system manufactured by Microsoft® Corporation and employs a Pentium® III microprocessor chip manufactured by Intel® Corporation as the processor. The computer 38 also includes a keyboard 42 and a mouse or a joy stick device 14 for inputting user information. However, as will be appreciated by those skilled in the art, other operating systems and microprocessor chips may be used. Further, it is not necessary to use a PC architecture. Other types of computers, such as the Apple® Macintosh computer manufactured by Apple Inc., or a special purpose or other general purpose computer may be used within the spirit and scope of the invention.

In the preferred embodiment, each ONS client 12 includes an input/output device 18 operative with a microphone 20 for receiving electrical signals over a microphone input line 34 representative of sound waves produced by a musical instrument such as, for instance, a recorder, clarinet, saxophone, violin or a trumpet or from the voice tract of a human. The input/output device 18 also accepts an electrical signal from a transducer 22, over a transducer input line 36, representative of the vibrations of the strings of, for instance, a guitar. Preferably, the input/output device 18 is a conventional sound card available from numerous vendors and adapted to conventional installation in the computer 38. Typically, the sound card 18 provides an audio amplifier, a bandpass filter and an analog-to-digital converter, each of a kind well known to those skilled in the art, for converting analog electrical signals 34 from the microphone 20 and analog electrical signals 36 from the transducer 22 into digital audio signals compatible with the computer 38. In the preferred embodiment, the analog microphone signals 34 and the transducer signals 36 are each sampled at a rate of 44.1 KHz., each sample being represented by a 16 bit word. Preferably, the samples are stored in the storage device as 1024 word buffers in either a .WAV or a .AIFF format. The input/output device further includes a synthesizer (not shown) connected to a loudspeaker 24, for generating sounds corresponding to the notes stored in the computer 38. As would be clear to those skilled in the art, the present invention is not limited to the aforementioned sample rate, buffer size, sample size and data format. Other sample rates, sample sizes, buffer sizes and data formats could be used within the spirit and scope of the invention.

Preferably, the computer 38 also includes a digital input/output port 44 for receiving digital input signals and outputting digital output signals conforming to the Musical Interface Device Interface (MIDI) specification along input/output line 28. The computer 38 also includes a video display 40 and a printer 16, where for instance, the notes played on a musical instrument or sung and stored in the storage device can be displayed or printed on paper or other media.

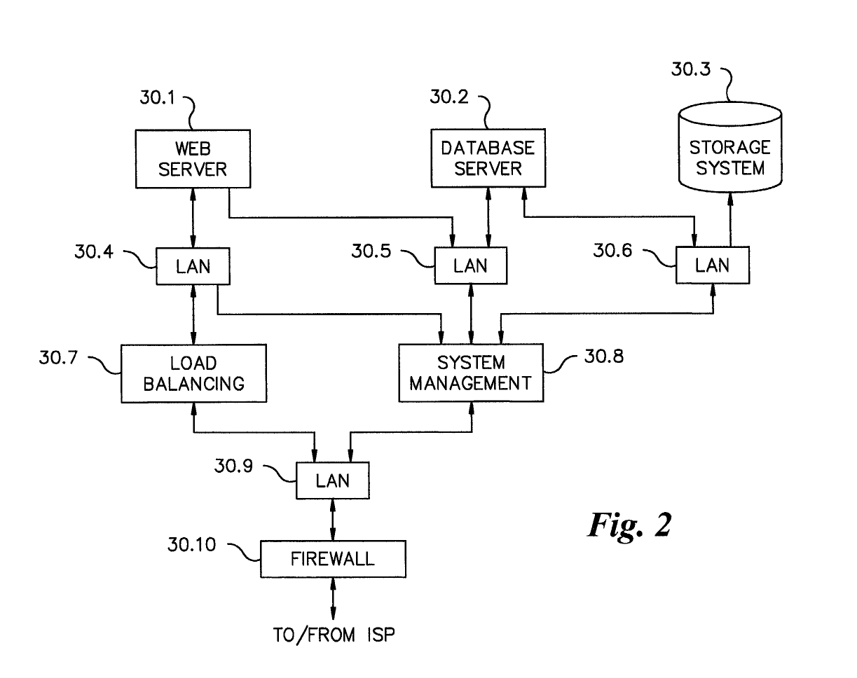

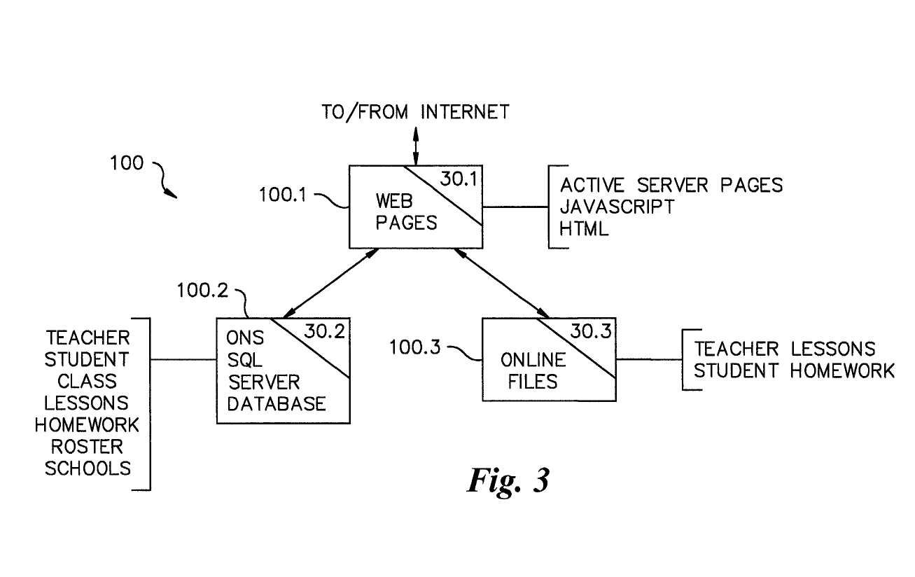

Referring now to FIG. 2 there is shown a block diagram of the ONS server 30 connected to the computer network 32. The ONS server 30 maintains a database (see FIG. 3) in a database server 30.2. The database includes information about each teacher, each student, each class and each lesson. When an ONS client 12 connects to the ONS server 30, the ONS server 30 provides a script to each ONS client 12 for executing a notation computer program in the ONS client computer 38. The notation computer program is utilized by each teacher to author lessons and by each student to author homework. When a lesson is completed, the lesson is transferred from the respective ONS client computer 12 under the control of the teacher, to the ONS server 30 for making the lesson accessible to a student who is a member of the class. Similarly, when the homework is completed, the homework is transferred from the respective ONS client computer 12 under the control of the student, to the ONS server 30 for making the homework accessible to the teacher. As will be understood to those skilled in the art, the terms “teacher”, “lessons”, “student” and “homework” are not to be strictly construed. The terms “teacher” and “lessons” should be applied generically to any person creating a musical composition with the ONS client 12 and transferring the musical composition to the ONS server 30, and the terms “student” and “homework” should be applied to a person who reviews, revises and/or adds commentary to the musical composition obtained from the ONS server 30 and provides the revised composition and/or comments back to the ONS server 30 for access by the teacher, such use of the aforementioned terms being within the spirit and scope of the invention.

Preferably, the ONS server 30 comprises a web server computer 30.1, the database server computer, 30.2, a load balancing computer 30.7, a system management computer 30.8 and a firewall computer 30.10 for connecting the ONS server 30 to the Internet. Preferably, the aforementioned computers are connected together by local area networks 30.4, 30.5 and 30.9. A storage system 30.3, comprising a plurality of hard disks, is connected to the database server computer 30.2 and the system management computer 30.8 by a local area network 30.6. Preferably, the computers 30.1, 30.2, 30.7, 30.8 and 30.10 are open architecture computers operating under a Windows operating system. However, as will be appreciated by those skilled in the art, the ONS server 30 need not be constrained to the computer architecture shown. The ONS server 30 could be implemented as multiple computers where an individual computer, 30.1, 30.2, 30.7, 30.8 and 30.10 is shown or with, for instance, as few as one computer provided the functions identified for the separate computers 30.1, 30.2, 30.7, 30.8 and 30.10 are implemented. Further the functions performed by the ONS server 30 and the functions performed by the ONS client 12 could be performed within the same computer(s), as, for instance, in a computer laboratory.

Referring now to FIG. 3 there is shown a preferred embodiment of the software architecture 100 of the ONS server 30. Preferably, the software in the ONS server 30 for implementing the present invention comprises three functional groupings: (1) web pages 100.1 comprising active web pages, javascript and hypertext markup language (HTML), stored in the web server computer 30.1; (2) the structured query language (SQL) ONS server database 100.2 stored in the database server computer 30.2; and (3) on-line files 100.3 comprising teacher lessons and student homework, stored in the storage system 30.3. Preferably, the ONS database 100.2 is a relational database containing information about students (registration information and marketing materials), teachers (registration information and marketing materials), classes (teacher, class codes and class names), lessons (student instructions, lesson names, file names of on-line files, and classes), class rosters (student names), schools (addresses and districts) and student submissions (student names, lesson information, class information, and file names of the on-line files).

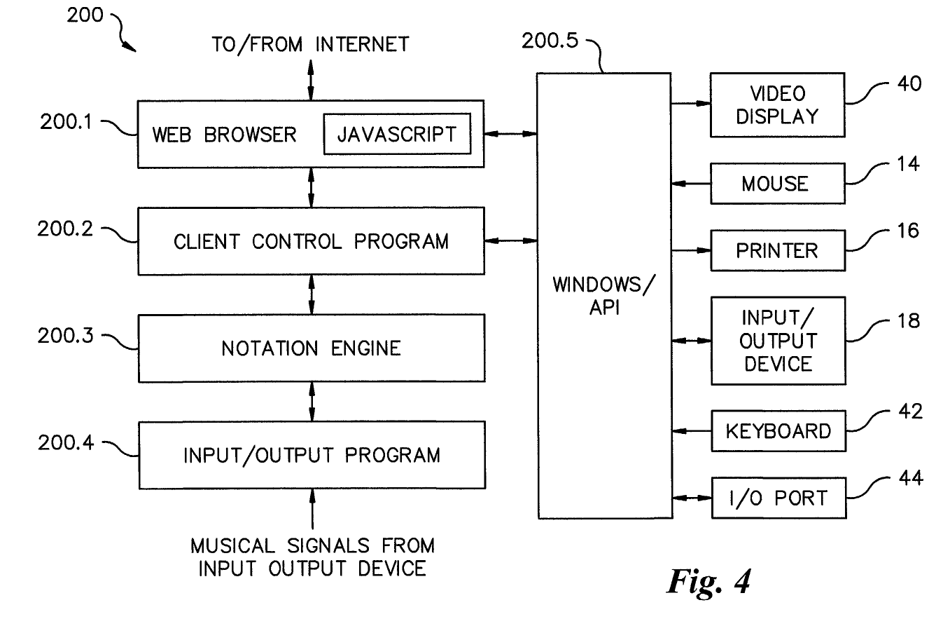

Referring now to FIG. 4 there is shown the software architecture 200 of an ONS client 12. Preferably, the client includes a web browser 200.1 whose functions include: (1) connecting the ONS client 12 to the ONS server 30, (2) transferring web pages between the ONS server 30 and the ONS client 12, (3) providing the web pages to the printer 16 and to the video display 40 and (4) interpreting the x, y location of a mouse click to send javascript commands embedded in the web page to a control computer program 200.2, a notation engine 200.3 or to the ONS server 30.

In the preferred embodiment, the javascript in the web page initially executes in the browser 200.1 to load the client control computer program 200.2. Thereafter the javascript interacts with the control computer program 200.2 to pass instructions from the web page to the control computer program 200.2. The control program 200.2 controls the notation engine 200.3 from the instructions received from the javascript residing in the browser 200.1.

Preferably, the browser 200.1 is the commercially available computer program entitled “Internet Explorer”, available from Microsoft Corporation. However, other browsers, such as the computer program “Netscape Navigator”, available from Netscape Corporation, are also suitable.

In the preferred embodiment, the control computer program 200.2 is computer code, downloadable over a computer network 32, which in connection with the web browser 200.1, allows the on-line notation service to function in the client computer 12 . The control program 200.2 attaches differently to the web browser 200.1 according to the browser type, be it Internet Explorer or Netscape Navigator. In the case of Internet Explorer, the control computer program 200.2 attaches to the browser 200.1 as an Active X control, and in the case of Netscape Navigator, it attaches as a plug-in.

In the preferred embodiment, the notation engine computer 200.3 is an ANSI compliant set of C++ objects responsible for generating a graphical music notation of a musical composition based on user inputs to the client 12, or from data within a web page received from the ONS server 30. The user inputs may originate from the mouse 14, from the keyboard 42, from a sound wave or an electrical signal by a musical instrument and received by the input/output device 18, or from a MIDI enabled instrument via the I/O port 44. An input/output computer program 200.4 accepts the digital audio data from the input/output device 18 (sound card) and converts the digital audio data to a MIDI data stream representative of the fundamental frequencies of the musical instrument providing the sound waves or electrical signals to the input/output device 18 (i.e. pitch-to MIDI conversion). Preferably, the input/output computer program 200.4 comprises of a monophonic pitch detection computer program, as described in U.S. Pat. No. 6,124,544. Alternatively a polyphonic pitch detection computer program may be used for the input/output computer program 200.4, as described in co-pending U.S. patent application No. ______, entitled “Apparatus for Detecting the Fundamental Frequencies Present in Polyphonic Music”, filed ______ which patent and patent application are hereby incorporated herein by reference in their entirety. As would be appreciated by those skilled in the art, other computer programs providing a pitch extraction capability could be used, within the spirit and scope of the invention.

The ONS client computer program 200 also provides a capability for displaying web pages, including screens generated by the browser 200.1, the control computer program 200.2, and the notation engine 200.3. The applications programmers interface (API) 200.5 which is provided as part of the Windows™ operating system is used in a conventional manner to interface the browser 200.1, and the control computer program 200.2 with the video display 40, the mouse 14, the printer 16, the keyboard 42, the input/output device 18 and the I/O port 44.

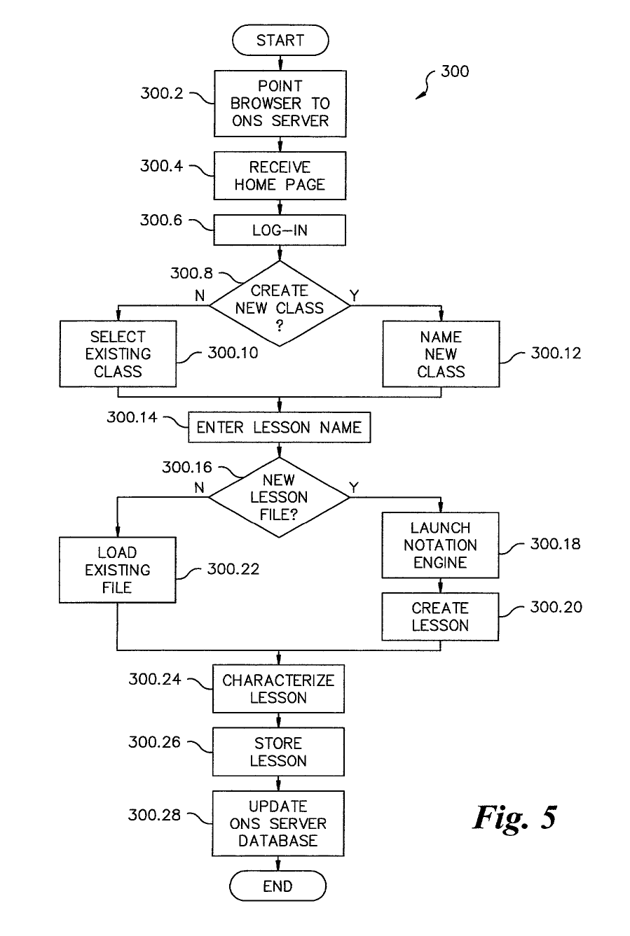

Referring now to FIG. 5 there is shown a flow diagram of a preferred embodiment of a method for a teacher utilizing an ONS client computer 38 connected to the Internet, to author a lesson for access by a class of students, and where each student in the class utilizes an ONS client computer 38 connected to the Internet (step 300) to access the lesson. At step 300.2, the teacher points the browser 200.1 to the ONS server 30 by entering the uniform resource locator (URL) of the ONS server 30 into the client computer 12. The ONS server 30 responds with the home page of the ONS (step 300.4). At step 300.6 the teacher logs-in to the ONS by entering an ID and a password. Alternatively, if the teacher has not yet registered with the ONS, the teacher can elect to register with the ONS by clicking on the sign-up button of the home page. A subsequent web page received from the ONS server 30 provides the teacher with fields for entering the teacher's name, e-mail address, screen name and password. The teacher is then given the option to enter information about the school the teacher is associated with (if any), a site name and an address of the teacher. The aforementioned information is entered into prescribed fields of the displayed web page by typing on the keyboard 42 of the ONS client computer 12. Following registration, the ONS server database 100.2 is updated with the teacher and school information.

Following log-in, the teacher is given an option (step 300.8) of creating a lesson for an existing class (step 300.10) or, if the teacher opts to create a new class, the teacher may enter a new class code into a specified field of the web page and indicate whether the class is/is not immediately available for students (step 300.12). The teacher may specify as many separate classes as desired. Following the creation of a new class, the ONS server database 100.2 is updated with the class information.

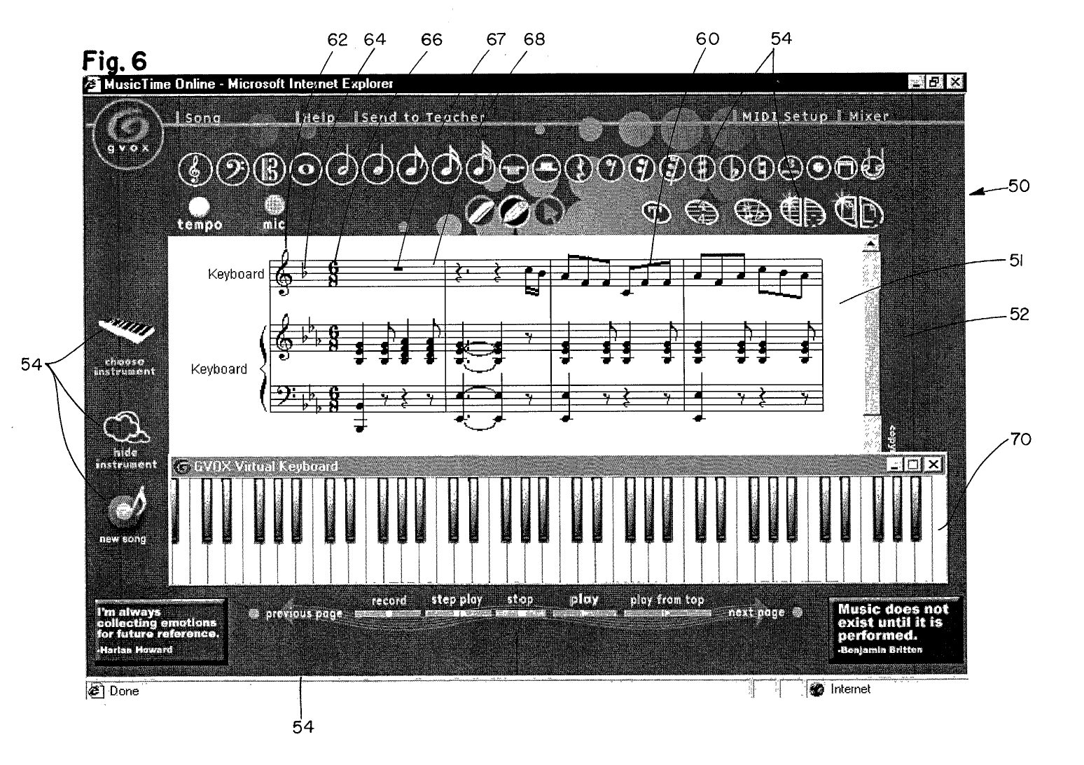

At step 300.14, the ONS server transmits a web page to the ONS client for the teacher to enter a name of a new lesson (step 300.14). At step 300.16 the teacher may elect to create a new lesson (steps 300.18-300.20), or use an existing lesson file which has been previously stored in the storage device of the computer 38 of the ONS client 12 (step 300.22). If the teacher opts to create new lesson by clicking on an appropriate button of the web page, the javascript within the web page transferred from the ONS server 30 causes the control program 200.2 to launch the notation engine computer program 200.3 and to display a notation screen 50 (FIG. 6) with a blank set of staves on the video display 40. At step 300.20, the teacher enters information into the computer 38 to form the lesson comprising a musical transcript and/or text utilizing the control program 200.2 and the notation engine computer program 200.3.

FIG. 6 is a pictorial representation of the notation screen 50 hosted by the client control computer program 200.2. In the center of FIG. 6 is the notation area 51 controlled by the ONS client 12 control computer program 200.2. The notation area 51 displays traditional music notation, comprising a plurality of staves 68 notated with notes 60, clefs 62, accidentals 64, time signature 66 and rests 67. Surrounding the notation area 51, is a web page 52 including various javascript implemented user interface buttons 54 that invoke various editing functions when a pointer is placed on one of the buttons 54 and the mouse 14 is clicked. The notational elements such as the notes 60, the clefs 62, the accidentals 64, the time signature 66 and the rests 67 are located on the staves 68 by the teacher or the student selecting the desired element on the web page 52 with the pointer/mouse and dragging the element to the desired location on the staves 68.

Also shown on the notation screen 50 is a representation of a musical keyboard 70 (i.e. virtual keyboard) which can also be used for inputting the notes 60 into the client computer 38 by pointing and clicking on the keys of the keyboard 70. In addition to the entry of the notes 60 into the client computer 38 by the virtual keyboard 70, the notes 60 can be entered into the client computer 38 by playing a MIDI enabled instrument and inputting a MIDI data stream via the I/O port 44; or by receiving sound waves produced by playing a musical instrument and processing the sound waves via the microphone 20 and the input/output device 18; or by processing the electrical signals from the transducer 22, as described above, to generate the MIDI data stream.

In addition to creating a transcript of a musical composition as described above, the preferred embodiment also provides for a person to listen to the notes of the transcript by playing back the transcript and generating a MIDI data stream corresponding to the notes played. The MIDI data stream may be listened to by applying the data stream to an external MIDI enabled instrument or to the synthesizer included within the input/output device 18. In the preferred embodiment, the virtual keyboard 70 will display whatever notes are being played back as the playback of the transcript occurs.

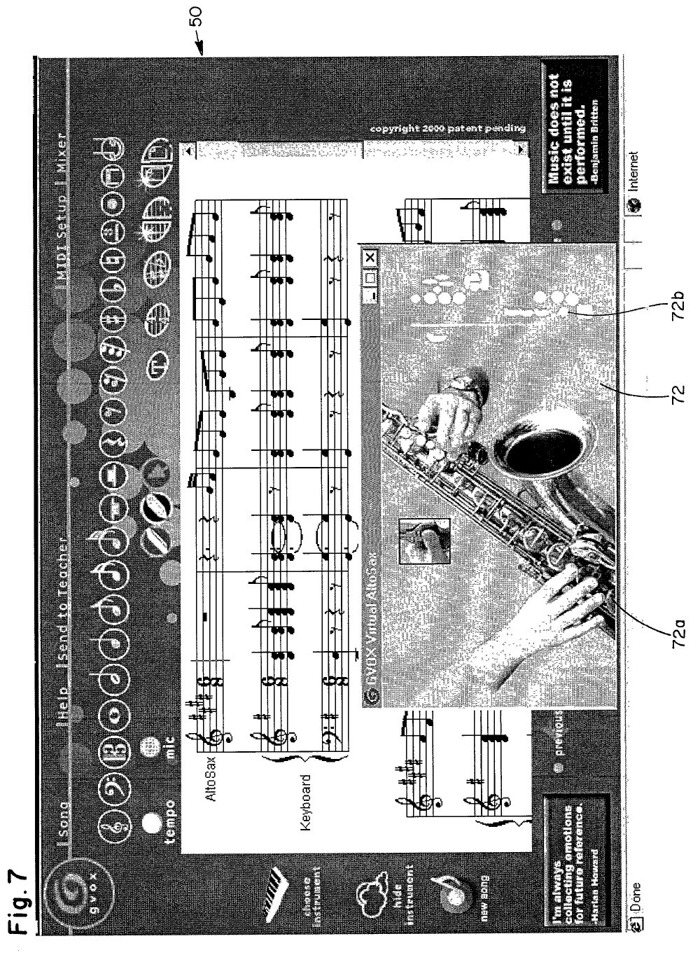

In addition to displaying the notes of the musical transcript on the virtual keyboard 70, the preferred embodiment also provides for displaying a virtual instrument display 72 (FIG. 7) of a person playing the notes of a musical instrument 72a. Preferably, a performer may select any instrument for display which produces a MIDI data stream or for which the ONS client 12 can convert digital audio data generated from the sound wave of the instrument into a MIDI data stream (i.e. pitch-to MIDI conversion).

Preferably, a separate representation of the person fingering the musical instrument is stored in the storage device of the client computer 38 for each note to be played on the instrument. The ONS client computer 38 selects the specific virtual instrument representation 72a to correspond with the note being played from the transcript and displays the virtual instrument representation 72a on the video display 40. An example of the virtual instrument representation of a saxophone being fingered to produce the note “C sharp” is shown in FIG. 7. In the preferred embodiment the virtual instrument representation 72a is a photographic image of the instrument and the portion of the person fingering the instrument. Preferably, the image clearly shows the keys, holes, valves, frets or slide of the respective instrument and the associated fingering by the person. The instrument may be selected by the person to be, for instance, a saxophone, a clarinet, a flute a recorder, a trumpet, a guitar or a violin. However, one skilled in the art will recognize that other instruments may be displayed, such as a cello, within the spirit and scope of the invention.

In addition to the photographic image 72a of the virtual representation of the instrument, a graphical representation 72b of the instrument is also shown in the virtual display 72. The graphical representation 72b indicates the fingering of the instrument by highlighting, positioning or otherwise indicating the keys, holes, valve, fret or slide positions of the instrument to make the note being played.

The preferred embodiment also provides a step-play method for providing information to a performer about the performer's performance of a transcript displayed by the ONS client computer 38 on the video display 40. When the step-play feature is enabled, the preferred embodiment waits until the user plays a highlighted note on the transcript. Using the pitch-to-MIDI capability and the virtual instrument display capability of the ONS client computer 38, the note being played is detected by the input/output program 200.4 and forward progress in displaying the transcript is delayed until the pitch of the played note corresponds to the pitch of the highlighted note in the transcript. If the pitch of the played note corresponds to the highlighted note of the transcript, the next note in the transcript is highlighted, and so-on. Preferably, the virtual instrument display 72 also responds to the pitch-to-MIDI and step-play by showing the correct fingering and also the fingering being played. If the performer's fingering does not correspond to the proper fingering, the incorrect fingering is highlighted in red.

Following the creation of the lesson at steps 300.18-300.20 or step 300.22, the teacher characterizes the lesson (step 300.24) by associating with the lesson a status, inserting a description of the lesson and notes available to other teachers. At step 300.26, the lesson is stored in the storage device of the computer 38 of the ONS client 12 and submitted to the ONS server 30 for storing in the on-line files 100.3 of the ONS server storage system 30.3. Additionally, the database 100.2 in the ONS server 30 is updated with information about the teacher, class, lesson etc.

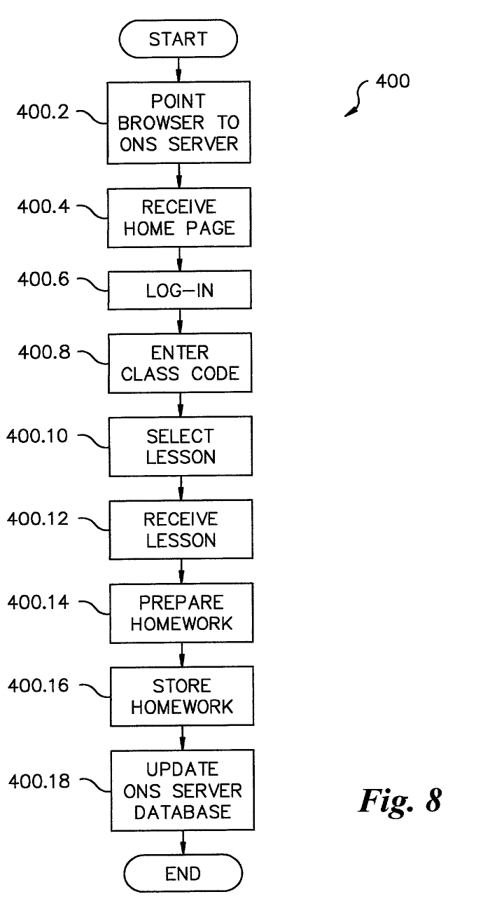

Referring now to FIG. 8, there is shown the preferred embodiment of a method (400) for a student, to access a lesson prepared by the teacher and to submit homework prepared by the student to the teacher. At step 400.2, the student points the browser 200.1 to the ONS server 30 by entering the URL of the ONS server 30 into the client computer 12. The ONS server 30 responds with the home page of the on-line music service (step 400.4). If the student is already registered, the student may log-in to the ONS by entering the student's ID, password and class code. If the student has not yet registered with the ONS, the student can elect to register with the ONS by clicking on the sign-up button of the ONS home page. A subsequent web page provides the student with fields for entering the students name, and the students teacher's name, e-mail address, screen name and password. The student may then log-in with the student's ID, password and class code of the class of which the student is a member (step 400.8). The aforementioned information is entered into the computer 12 into prescribed fields of the displayed web page by typing on the keyboard 42.

Upon entry of the class code at step 400.8, the ONS client 12 requests a lessons web page from the ONS server 30. The lessons web page received at the ONS client 12 includes a list of the lessons stored on the ONS server 30 for which the student has access. At step 400.10, the student selects a specific lesson to work on by clicking on a button on the lessons web page. In response to the student clicking on a button associated with the selected lesson, the javascript within the web page: (1) causes: the client control program 200.2 to launch the notation engine computer program 200.3 and display the notation area 51 with a blank set of staves on the video display 40 and (2) requests the ONS server 30 to transfer the selected lesson from the corresponding on-line file 100.3 in the ONS server 30 to the ONS client 12 and to display the selected lesson in the notation area 51 of the display (step 400.12).

In addition to recording a lesson as described above, the student may listen to the lesson using an external MIDI enable instrument or with the synthesizer included within the input/output device 18. In this case the keyboard 70 will display whatever notes are being played back as the playback occurs.

At step 400.14, the student prepares the homework by utilizing the editing capabilities of the client computer program 200.2 and the notation engine 200.3

At step 400.16, the lesson is stored in the storage device of the computer 38 of the ONS client 12 and submitted to the ONS server 30 for storing in the on-line files 100.3 of the ONS server storage system 30.3. Additionally, the database 100.2 in the ONS server 30 is updated with information about the lesson (step 400.18).

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A system for making a lesson authored by a teacher accessible to a class of one or more students, and for making homework authored by a student belonging to the class accessible to the teacher, the system comprising:
a first client computer connected to a computer network, the first client computer being under the control of the student;
a second client computer connected to the computer network, the second client computer being under the control of the teacher; and
a server computer connected to the computer network, the server computer maintaining a database including information about the teacher, the student, the class and the lesson, wherein the server computer provides a script to the first client computer and to the second client computer for executing a notation computer program in the first and in the second client computers, whereby the notation computer program is utilized to author at least one of the lesson and the homework and wherein the at least one of the lesson and the homework is transferred from the respective first and the second client computer to the server computer for making the at least one of the lesson and the homework accessible to one of the students of the class and the teacher.

2. The system according to claim 1, wherein the first and the second client computers each have a browser, wherein the browser receives the script from the server computer and provides the script to a control computer program whereby the control computer program provides instructions to the notation computer program.

3. The system according to claim 1, wherein the server computer includes a storage system for storing on-line files comprising the lessons and the homework.

4. A method for making a lesson authored by a teacher accessible to a class of one or more students, and for making homework authored by one of the students belonging to the class accessible to the teacher, the method comprising the steps of:
connecting a first client computer to a computer network, the first client computer being under the control of the student;
connecting a second client computer to the computer network, the second client computer being under the control of the teacher; and
connecting a server computer to the computer network, the server computer maintaining a database including information about the teacher, the student, the class and the lesson, wherein the server computer provides a script to the first client computer and to the second client computer for enabling the execution of a notation computer program in the first and the second client computers, whereby the notation computer program is utilized to author at least one of the lesson and the homework and wherein the at least one of the lesson and the homework is transferred from the respective first and the second client computer to the server computer for making the at least one of the lesson and the homework accessible to at least one of the students of the class and the teacher.

5. A method for a teacher to author a lesson which is accessible to a class of one or more students, the method comprising the steps of:
connecting a client computer under the control of the teacher to a server computer;
entering a class code associated with a class into the client computer and transferring the class code to the server computer;
transferring a script from the server computer to the client computer in response to a request from the client computer, wherein the script causes a music notation computer program to execute in the client computer;
entering musical information into the client computer to form the lesson, the lesson comprising at least one of a musical transcript and text formed by utilizing the music notation computer program; and
transferring the lesson from the client computer to the server computer wherein the lesson is accessible to the class of one or more students.

6. The method according to claim 5, wherein the first client computer comprises a browser for connecting the client computer to the server.

7. The method according to claim 5, wherein the script is transferred from the server computer to the client computer as a portion of a world wide web page.

8. The method according to claim 5, wherein the musical information is entered as at least one of a keystroke from a keyboard and a click from a mouse device.

9. The method according to claim 5, wherein the musical information is entered by receiving musical sounds produced by one of a musical instrument and a vocalist.

10. The method according to claim 5, wherein the musical information is entered by receiving a stream of data representing parameters corresponding to notes produced by a musical instrument.

11. The method of claim 5, wherein the musical transcript comprises a staff including at least one note.

12. The method of claim 5, further including the step of playing at least a portion of the musical transcript, wherein the at least one note is highlighted on a display device as the at least one note is played.

13. The method according to claim 11, further including the step of synthesizing an audio signal corresponding to the pitch of the at least one note as the at least one note is played.

14. The method according to claim 11, further including the step of displaying the fingering of a musical instrument as the at least one note is played.

15. A method for a student to gain access to a lesson prepared by a teacher and for the student to submit homework to the teacher, the method comprising the steps of:
connecting a first client computer under the control of the student to a server computer;
entering a class code associated with a class of one or more of the students into the first client computer and transferring the class code to the server computer;
receiving from the server computer, a list of lessons which are stored in the server computer and which are available to the students belonging to the class;
requesting access to one of the lessons stored in the server computer, the requested lesson having been previously transferred to the server computer from a second client computer, the second client computer being under the control of the teacher;
transferring the requested lesson from the server computer to the first client computer in response to the request from the first client computer, whereupon a script within the requested lesson causes a music notation computer program to execute in the first client computer, thereby making the requested lesson accessible to the student;
entering the homework into the first client computer, the homework comprising at least one of a musical transcript and text formed by the music notation program; and
transferring the homework from the first client computer to the server computer wherein the homework is accessible to the teacher.

16. The method according to claim 15, wherein the first client computer comprises a browser for connecting the first client computer to the server.

17. The method according to claim 15, wherein the script is transferred from the server computer to the first client computer as a portion of a world wide web page.

18. The method according to claim 15, wherein homework is entered as at least one of a keystroke from a keyboard and a click from a mouse device.

19. The method according to claim 15, wherein the homework is entered by receiving musical sounds produced by one of a musical instrument and a vocalist.

20. The method according to claim 15, wherein homework is entered by receiving a stream of data representing parameters corresponding to notes produced by a musical instrument.

21. The method according to claim 15, wherein the student gains access to the lesson by entering an ID and a password into the first client computer in addition to the class code.

22. The method of claim 15, wherein the lesson comprises at least one of a musical transcript and text and the homework comprises a revision of the musical transcript.

23. The method of claim 15, wherein the musical transcript comprises a staff including at least one note.

24. The method of claim 23, further including the step of playing at least a portion of the musical transcript wherein the at least one note is highlighted on a display device as the at least one note is displayed.

25. The method according to claim 23, further including the step of synthesizing an audio signal for producing a sound corresponding to a pitch of the at least one note.

26. The method according to claim 23, further including the step of displaying the fingering of a musical instrument as the at least one note is played.

27. An apparatus for displaying a virtual representation of a person playing a musical instrument, said apparatus comprising:
a storage device for storing the virtual representation of said person playing the instrument;
a computer connected to the storage device for receiving a command specifying a note to be played and for selecting the virtual representation stored in the storage device to correspond with the playing of the specified note; and
a video display connected to the computer for receiving and displaying the virtual representation of the person playing the specified note on the musical instrument.

28. A method for displaying a virtual representation of a musical instrument being played by a person, the method comprising the steps of:
storing the virtual representation of the person playing the instrument;
receiving a command specifying a note to be played;
selecting the virtual representation to correspond with the specified note; and
displaying the virtual representation of the person playing the specified note.

29. The method according to claim 28, wherein the musical instrument is selected from the group consisting of an alto saxophone, a clarinet, a flute, a recorder, a tenor saxophone, a trombone, a trumpet a guitar, and a violin.

30. The method according to claim 28, further including the step of displaying a staff including the note to be played, wherein the note is played by selecting the note on the staff.

31. The method according to claim 28, wherein the virtual representation of the person playing the instrument is a photographic image.

32. The method according to claim 31, wherein the virtual representation of the person playing the musical instrument includes a representation of one of keys, holes, valves, frets and slide of the instrument.

33. The method according to claim 28 wherein the virtual representation comprises a graphical representation of the musical instrument, the graphical representation indicating the playing of the specified note by indicating one of a key, a hole, a valve position, a fret and a slide position.

34. A method for providing information to a performer about a musical performance of a musical composition, the method comprising the steps of:
displaying a musical transcript of the composition;
highlighting a first note of the composition as registered on the transcript;
comparing a first note of the performance with the first note of the composition;
highlighting a second note of the composition if the first note of the performance matches the first note of the composition; and
continuing to highlight the first note of the composition until the first note of the performance matches the first note of the composition.

35. The method of claim 34, wherein the transcript comprises at least one staff, the at least one staff including the first and the second notes.

36. The method of claim 34, wherein a match occurs when a difference between a pitch of the first note of the performance and a pitch of the first note of the composition is less than a predetermined value.
